(19) United States
(12) Patent Application Publication
(10) Pub. No.: US 2017/0253500 A1
(43) Pub. Date: Sep. 7, 2017

(54) WATER CONDITIONING

(71) Applicant: Aquaphex Total Water Solutions, LLC, Southlake, TX (US)

(72) Inventor: Gregory G. Jones, Southlake, TX (US)

(21) Appl. No.: 15/059,066

(22) Filed: Mar. 2, 2016

(51) Int. Cl. C02F 1/44; B01D 69/02; B01D 71/02; C02F 1/48

(52) U.S. Cl. CPC C02F 1/44; C02F 1/48; B01D 69/02; B01D 71/024; B01D 71/025; B01D 71/027; C02F 2101/325

(57) ABSTRACT

A water conditioning apparatus for separating organic compounds and dissolved solids from water. A membrane separates organic compounds from a liquid feed comprising water, organic compounds, and dissolved solids. A fluid passageway receives from the membrane, liquid from which the membrane has separated organic compounds, and allows the liquid to flow through the passageway. Magnets are disposed and oriented such that liquid flowing through the passageway passes through a magnetic field effect produced by the magnets. A precipitator receives fluid that has flowed through the magnetic field effect and collects particles that the magnetic field effect has caused to precipitate from the fluid.

### CROSS-REFERENCES TO RELATED APPLICATIONS

This application claims the benefit of the filing dates of U.S. Provisional Patent Application Ser. No. 62/127,034 filed Mar. 2, 2015 and U.S. Provisional Patent Application Ser. No. 62/132,283 filed Mar. 12, 2015.

### STATEMENT REGARDING FEDERALLY SPONSORED RESEARCH OR DEVELOPMENT

Not Applicable

### BACKGROUND

Field

This application relates generally to water filtration.

Description of Related Art Including Information Disclosed Under 37 Cfr 1.97 And 1.98

Water used in hydraulic fracturing operations is generally disposed of following use, typically via injection wells that are used to deposit the water deep underground. The water is rarely filtered, cleaned or treated in any way before disposal.

### SUMMARY

A water conditioning apparatus is provided for separating organic compounds and dissolved solids from water. The apparatus comprises a membrane configured to separate organic compounds from a liquid feed comprising water, organic compounds, and dissolved solids. The apparatus also comprises a fluid passageway configured and positioned to receive from the membrane, liquid from which the membrane has separated organic compounds, and further configured to allow the liquid to flow through the passageway. Magnets are disposed and oriented such that liquid flowing through the passageway passes through a magnetic field effect produced by the magnets, and a precipitator is configured and positioned to receive fluid that has flowed through the magnetic field effect and to collect particles that the magnetic field effect has caused to precipitate from the fluid.

A method is provided for conditioning water comprises separating non-polar organic compounds from a liquid feed comprising water, organic compounds, and dissolved solids, then flowing the liquid feed through a functionalized porous ceramic membrane. Dissolved solids may then separated from the liquid feed by flowing the liquid through a magnetic field effect, and particles precipitated from the fluid may be collected by passage through the magnetic field effect.

### DRAWING DESCRIPTIONS

FIG. 1 is a schematic process flow diagram of a water conditioning apparatus for separating organic compounds and dissolved solids from water; and

FIG. 2 is a flow chart showing a method for conditioning water.

### DETAILED DESCRIPTION

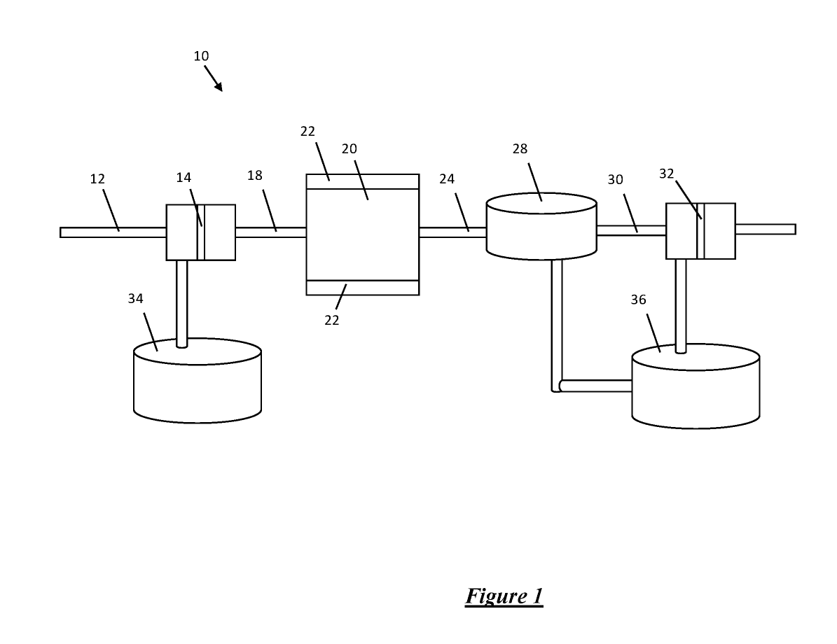

FIG. 1 shows a water conditioning apparatus 10 for separating organic compounds and dissolved solids from, for example, flowback or produced water from hydraulic fracturing operations, so that the water can be used or re-used for purposes such as hydraulic fracturing operations. The apparatus 10 may include a membrane 14 configured to separate organic compounds from a liquid feed 12 comprising water, organic compounds, and dissolved solids. The separated organic compounds may be directed into an organic compound holding tank 34. The apparatus 10 may also include a fluid passageway 20 configured and positioned to receive from the membrane 14, liquid 18 from which organic compounds have been separated by the membrane 14, and to allow the received liquid 18 to flow through the passageway 20. Magnets 22 are disposed and oriented such that liquid flowing through the passageway 20 passes through a magnetic field effect produced by the magnets 22. A precipitator 28 may be configured and positioned to receive fluid 24 that has flowed through the magnetic field effect and to collect particles that the magnetic field effect has caused to precipitate from the fluid. Precipitated or separated particles or solids may be collected in a reservoir 36.

The membrane 14 may comprise an elongated porous ceramic body having first and second ends, and an outer peripheral edge surface extending between the first and second ends. The porous ceramic body may define one or more longitudinal flow channels, each of which is defined by an inner surface. The channels may extend between the first and second ends. The porous ceramic body may be functionalized with hydrophilic organic acid molecules such that the membrane 14 is rendered organophobic.

The hydrophillic organic acid molecules may be chemically bound to and within the porous ceramic body from the inner surfaces of the flow channels to the outer peripheral edge surface. The inner surfaces of the longitudinal flow channels may be provided by one or more porous ceramic coatings.

The porous ceramic body may have an average pore size ranging from about 0.01 μm to about 1.4 μm, and in which a first porous ceramic coating is disposed over the porous ceramic body within the longitudinal flow channels, the first porous ceramic coating in each flow channel having an average pore size ranging from about 0.01 μm to about 1.4 μm.

Each of the porous ceramic body and the first porous ceramic coating may be composed of a crystalline ceramic oxide. Each of the porous ceramic body and the first porous ceramic coating may be composed of alumina, titania, silica, magnesia, zirconia, or a combination thereof.

The porous ceramic body may have an average pore size ranging from about 0.01 μm to about 5 μm and may be composed of alumina, titania, silica, magnesia, zirconia, or a combination thereof.

The hydrophilic organic acid molecules may include a functional group that can react with the ceramic of the porous ceramic body to form an organo-metal bond, and/or may include a carboxylic acid functional group. The hydrophilic organic acid molecules may include one or more of cysteic acid, 3,5-diiodotyrosine, trans-fumaric acid, malonic acid, octanoic acid, stearic acid, 3,5-dihydroxybenzoic acid, parahydroxy benzoic acid groups, or combinations thereof. The hydrophilic organic acid molecules may also or alternatively include cysteic acid.

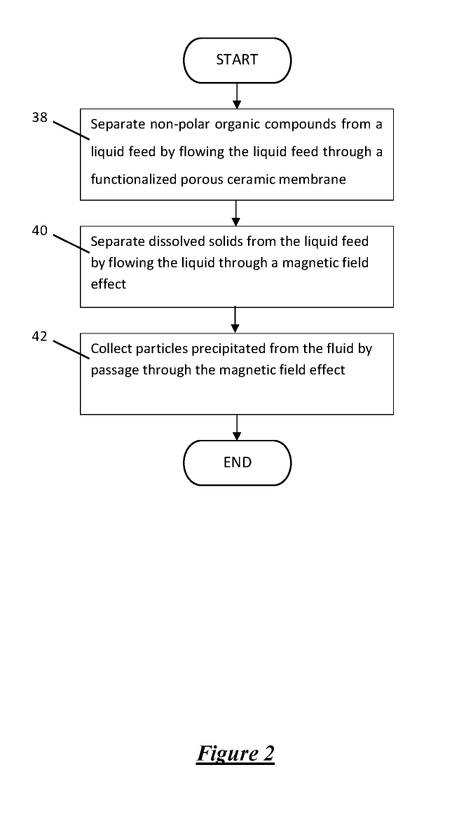

A method is provided for conditioning water for use or re-use in, for example, hydraulic fracturing operations. The method may include separating non-polar organic compounds from a liquid feed 12 comprising water, organic compounds, and dissolved solids, by flowing the liquid feed 12 through a functionalized porous ceramic membrane 14, as shown in action step 38 of FIG. 2. Dissolved solids may then be separated from the liquid feed by flowing the liquid through a magnetic field effect as shown in action step 40. Particles precipitated from the fluid by passage through the magnetic field effect may then be collected as shown in action step 42.

The functionalized porous ceramic membrane 14 used to practice this method may include an elongated porous ceramic body having a first end, a second end, and an outer peripheral edge surface extending between the first and second ends, the porous ceramic body defining one or more longitudinal flow channels, each of which is defined by an inner surface, that extend between the first and second ends, and in which the porous ceramic body is functionalized with hydrophilic organic acid molecules to render the membrane 14 organophobic, the hydrophillic organic acid molecules being chemically bound to and within the porous ceramic body from the inner surfaces of the flow channels to the outer peripheral edge surface. A liquid feed 12 may be provided that includes a mixture or emulsion of non-polar organic compounds and polar compounds through the longitudinal flow channels of the membrane 14, the membrane 14 allowing polar compounds to flow transversely from the inner surfaces of the longitudinal flow channels across the outer peripheral edge surface of the porous ceramic body while rejecting non-polar organic compounds, the liquid feed 12 having a greater concentration of non-polar organic compounds upon exiting the longitudinal flow channels than when entering the flow channels.

The liquid feed 12 provided in practicing the method may include hydrocarbons and water such as are found in frac water.

The inner surfaces of the longitudinal flow channels used in practicing the method may be provided by one or more porous ceramic coatings.

The porous ceramic body employed in practicing the method may have an average pore size ranging from about 0.01 μm to about 1.4 μm, and in which a first porous ceramic coating is disposed over the porous ceramic body within the longitudinal flow channels, the first porous ceramic coating in each flow channel having an average pore size ranging from about 0.01 μm to about 1.4 μm.

Each of the porous ceramic body and the first porous ceramic coating used in practicing the method may be composed of a crystalline ceramic oxide, and/or may be composed of alumina, titania, silica, magnesia, zirconia, or a combination thereof. The porous ceramic body may have an average pore size ranging from about 0.01 μm to about 5 μm and may be composed of alumina, titania, silica, magnesia, zirconia, or a combination thereof.

The hydrophilic organic acid molecules used in practicing the method may include a functional group that can react with the ceramic of the porous ceramic body to form an organo-metal bond. The hydrophilic organic acid molecules may include a carboxylic acid functional group. The hydrophilic organic acid molecules may include one or more of cysteic acid, 3,5-diiodotyrosine, trans-fumaric acid, malonic acid, octanoic acid, stearic acid, 3,5-dihydroxybenzoic acid, parahydroxy benzoic acid groups, or combinations thereof.

The water conditioning apparatus 10 may also include a second membrane 32 configured and positioned to receive from the precipitator 28, liquid 30 from which the precipitator 28 has precipitated particles, and to separate remaining solids from that liquid 30. The second membrane 32 may comprise hydrophilic modified PAN or PES. The second membrane 32 may comprise a hollow fiber defining a second longitudinal flow channel or, preferably, a bundle of hollow fibers comprising respective longitudinal flow channels.

In practice, where the apparatus 10 includes a second membrane 32 as described above, remaining solids may be separated from the fluid by passing the fluid through the second membrane 32, e.g., by passing the fluid through a bundle of hollow fibers comprising respective longitudinal flow channels, the flow being directed from outside-in such that solids remain outside the fibers and filtrate is allowed to pass laterally into and along the longitudinal flow channels and out through respective exit ends of the second longitudinal flow channels.

This description, rather than describing limitations of an invention, only illustrates (an) embodiment(s) of the invention recited in the claims. The language of this description is therefore exclusively descriptive and is non-limiting. Obviously, it's possible to modify this invention from what the description teaches. Within the scope of the claims, one may practice the invention other than as described above.

1. A water conditioning apparatus for separating organic compounds and dissolved solids from water, the apparatus comprising:
a membrane configured to separate organic compounds from a liquid feed comprising water, organic compounds, and dissolved solids;
a fluid passageway configured and positioned to receive from the membrane, liquid from which the membrane has separated organic compounds, and further configured to allow the liquid to flow through the passageway;
magnets disposed and oriented such that liquid flowing through the passageway passes through a magnetic field effect produced by the magnets; and
a precipitator configured and positioned to receive fluid that has flowed through the magnetic field effect and to collect particles that the magnetic field effect has caused to precipitate from the fluid.

2. A water conditioning apparatus as set forth in claim 1, in which:
the membrane comprises a porous ceramic body defining one or more longitudinal flow channels, each of which is defined by an inner surface; and
the porous ceramic body is functionalized with hydrophilic organic acid molecules such that the membrane is rendered organophobic.

3. A water conditioning apparatus as set forth in claim 2, in which the hydrophillic organic acid molecules are chemically bound to and within the porous ceramic body from the inner surfaces of the flow channels to the outer peripheral edge surface.

4. A water conditioning apparatus as set forth in claim 1, in which the inner surfaces of the longitudinal flow channels are provided by one or more porous ceramic coatings.

5. A water conditioning apparatus as set forth in claim 4, in which the porous ceramic body has an average pore size ranging from about 0.01 μm to about 1.4 μm, and in which a first porous ceramic coating is disposed over the porous ceramic body within the longitudinal flow channels, the first porous ceramic coating in each flow channel having an average pore size ranging from about 0.01 μm to about 1.4 μm.

6. A water conditioning apparatus as set forth in claim 5, in which each of the porous ceramic body and the first porous ceramic coating are composed of a crystalline ceramic oxide.

7. A water conditioning apparatus as set forth in claim 4, in which each of the porous ceramic body and the first porous ceramic coating are composed of alumina, titania, silica, magnesia, zirconia, or a combination thereof.

8. A water conditioning apparatus as set forth in claim 1, in which the porous ceramic body has an average pore size ranging from about 0.01 μm to about 5 μm and is composed of alumina, titania, silica, magnesia, zirconia, or a combination thereof.

9. A water conditioning apparatus as set forth in claim 1, in which the hydrophilic organic acid molecules include a functional group that can react with the ceramic of the porous ceramic body to form an organo-metal bond.

10. A water conditioning apparatus as set forth in claim 9, in which the hydrophilic organic acid molecules include a carboxylic acid functional group.

11. A water conditioning apparatus as set forth in claim 10, in which the hydrophilic organic acid molecules include one or more of cysteic acid, 3,5-diiodotyrosine, trans-fumaric acid, malonic acid, octanoic acid, stearic acid, 3,5-dihydroxybenzoic acid, parahydroxy benzoic acid groups, or combinations thereof.

12. A water conditioning apparatus as set forth in claim 11, in which the hydrophilic organic acid molecules include cysteic acid.

13. A method for conditioning water, the method comprising the steps of:
separating non-polar organic compounds from a liquid feed comprising water, organic compounds, and dissolved solids, by flowing the liquid feed through a functionalized porous ceramic membrane;
separating dissolved solids from the liquid feed by flowing the liquid through a magnetic field effect; and
collecting particles precipitated from the fluid by passage through the magnetic field effect.

14. The method of claim 13, in which the step of separating non-polar organic compounds includes:
providing a functionalized porous ceramic membrane comprising one or more longitudinal flow channels and functionalized with hydrophilic organic acid molecules to render the membrane organophobic, the hydrophillic organic acid molecules being chemically bound to and within the porous ceramic body; and
flowing a liquid feed into the longitudinal flow channels of the membrane, the liquid feed including a mixture or emulsion of non-polar organic compounds and polar compounds, the membrane allowing polar compounds to depart the flow channels and flow transversely through the membrane from the flow channels to an outer peripheral edge surface of the porous ceramic body, while rejecting and allowing non-polar organic compounds to continue flowing out respective exit ends of the flow channels.

15. The method set forth in claim 13, in which the organic compounds include hydrocarbons.

16. The method set forth in claim 15, in which the inner surfaces of the longitudinal flow channels are provided by one or more porous ceramic coatings.

17. The method set forth in claim 16, in which the porous ceramic body has an average pore size ranging from about 0.01 μm to about 1.4 μm, and in which a first porous ceramic coating is disposed over the porous ceramic body within the longitudinal flow channels, the first porous ceramic coating in each flow channel having an average pore size ranging from about 0.01 μm to about 1.4 μm.

18. The method set forth in claim 17, in which each of the porous ceramic body and the first porous ceramic coating are composed of a crystalline ceramic oxide.

19. The method set forth in claim 18, in which each of the porous ceramic body and the first porous ceramic coating are composed of alumina, titania, silica, magnesia, zirconia, or a combination thereof.

20. The method set forth in claim 13, in which the porous ceramic body has an average pore size ranging from about 0.01 μm to about 5 μm and is composed of alumina, titania, silica, magnesia, zirconia, or a combination thereof.
